(19) United States
(12) Patent Application Publication
(10) Pub. No.: US 2016/0085487 A1
(43) Pub. Date: Mar. 24, 2016

(54) DOCUMENT PROCESSING SYSTEM, NON-TRANSITORY COMPUTER READABLE MEDIUM, DOCUMENT PROCESSING APPARATUS, AND DOCUMENT PROCESSING METHOD

(71) Applicant: FUJI XEROX CO., LTD., Tokyo (JP)

(72) Inventor: Koichi IMAI, Kanagawa (JP)

(73) Assignee: FUJI XEROX CO., LTD., Tokyo (JP)

(21) Appl. No.: 14/680,160

(22) Filed: Apr. 7, 2015

(30) Foreign Application Priority Data
Sep. 24, 2014 (JP) 2014-194413

(51) Int. Cl. G06F 3/12; H04N 1/00; H04L 12/58

(52) U.S. Cl. CPC G06F 3/1222; H04L 51/08; H04N 1/00244; H04N 1/00212; G06F 3/1238; G06F 3/1286; G06F 3/1287; H04N 2201/0094

(57) ABSTRACT

A document processing system includes an information receiving unit, a document obtaining unit, an identifying unit, and a processing unit. The information receiving unit receives, from a user terminal, authentication information for obtaining document data, the authentication information being generated in response to registration of the document data on a server, and user identifiable information. The document obtaining unit obtains the document data from the server by using the authentication information. The identifying unit identifies user identification information by using the user identifiable information. The processing unit processes the document data and the user identification information in association with each other.

### CROSS-REFERENCE TO RELATED APPLICATIONS

This application is based on and claims priority under 35 USC 119 from Japanese Patent Application No. 2014-194413 filed Sep. 24, 2014.

### BACKGROUND

(i) Technical Field

The present invention relates to a document processing system, a non-transitory computer readable medium, a document processing apparatus, and a document processing method.

(ii) Related Art

In general, different forms of authentication are employed in a system within an organization to which a user belongs and in a system outside the organization, such as in a server on the Internet. In a case where a user is to use, in the system within the organization, data that the user has stored on the server outside the organization while being out, for example, a situation may arise where the user is unable to access, via the system within the organization, the data stored on the server outside the organization because the form of authentication for the system within the organization is different from that for the server outside the organization. Another conceivable usage scenario is where a user downloads document data from the server outside the organization to a terminal owned by the user, and thereafter uses the document data stored on his/her terminal in the system within the organization to which the user belongs when returning to the organization.

### SUMMARY

According to an aspect of the invention, there is provided a document processing system including an information receiving unit, a document obtaining unit, an identifying unit, and a processing unit. The information receiving unit receives, from a user terminal, authentication information for obtaining document data, the authentication information being generated in response to registration of the document data on a server, and user identifiable information. The document obtaining unit obtains the document data from the server by using the authentication information. The identifying unit identifies user identification information by using the user identifiable information. The processing unit processes the document data and the user identification information in association with each other.

### BRIEF DESCRIPTION OF THE DRAWINGS

An exemplary embodiment of the present invention will be described in detail based on the following figures, wherein:

FIG. 1 is a diagram illustrating a configuration of a document processing system according to an exemplary embodiment;

FIG. 2 is a diagram illustrating a hardware configuration of a document management server;

FIG. 3 is a diagram illustrating an example of data storage in a document storage database stored on a memory of a document storage server;

FIG. 4 is a functional block diagram according to the exemplary embodiment;

FIG. 5 is a diagram illustrating an example of data storage in a print job database;

FIG. 6 is a diagram illustrating an example of data storage in a company database;

FIG. 7 is a diagram illustrating an example of data storage in a job management database;

FIG. 8 is a flowchart illustrating a process performed in the exemplary embodiment;

FIG. 9 is a flowchart illustrating a process performed in the exemplary embodiment; and

FIG. 10 is a functional block diagram according to modifications.

### DETAILED DESCRIPTION

Hereinafter, an exemplary embodiment of the present invention will be described with reference to the drawings.

### 1. Exemplary Embodiment

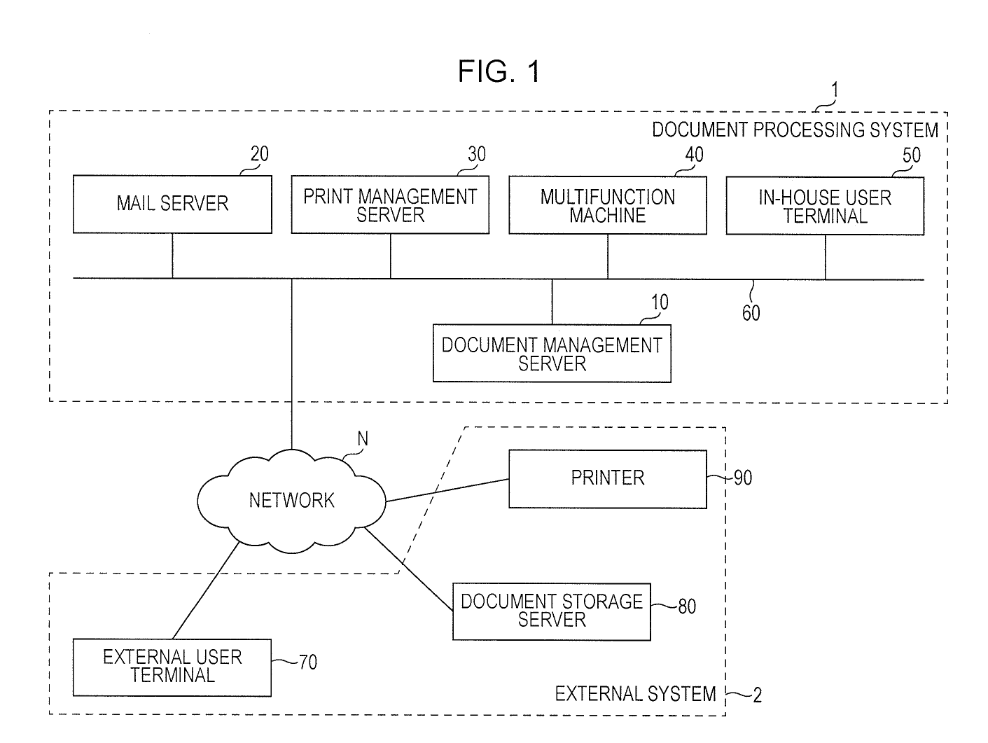

FIG. 1 is a diagram illustrating a configuration of a document processing system 1 according to an exemplary embodiment. As illustrated in FIG. 1, the document processing system 1 includes a document management server 10 (document processing apparatus or computer), a mail server 20, a print management server 30, a multifunction machine 40, and an in-house user terminal 50, for example. In this exemplary embodiment, a case is described where the document processing system 1 is used in a company to which plural users belong. The apparatuses in the document processing system 1 are connected to one another via a local area network (LAN) 60 in the company so as to be able to transmit and receive data. Note that a description is given while assuming that the document processing system 1 includes one of each of the apparatuses; however, any of the apparatuses may be provided in plural.

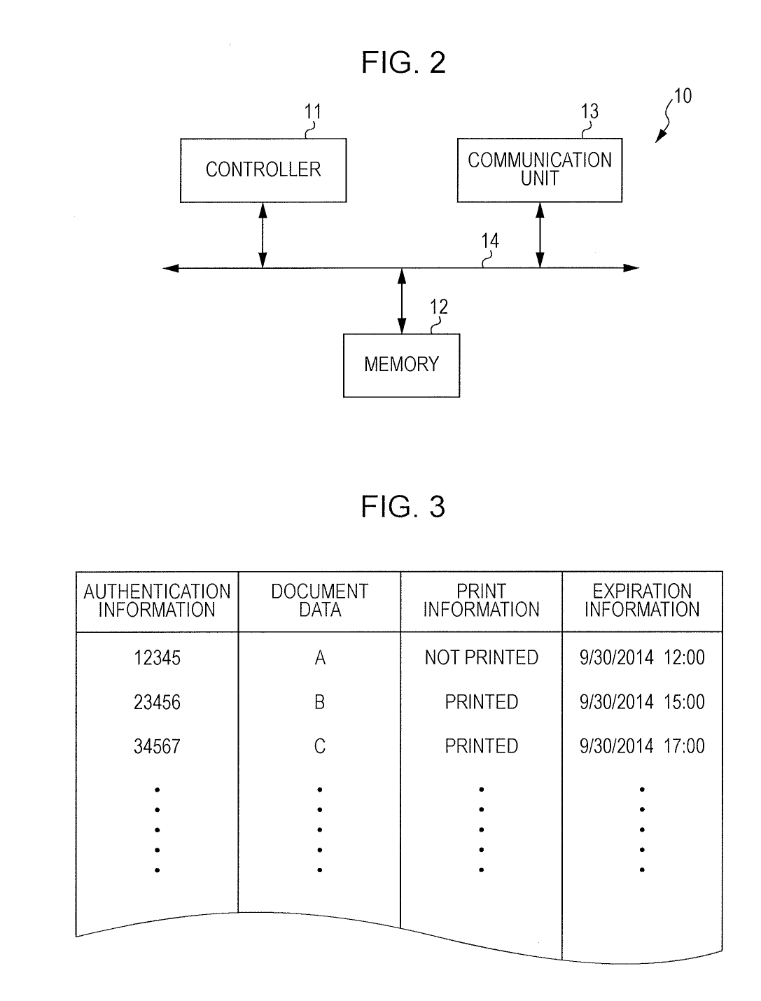

FIG. 2 is a diagram illustrating a hardware configuration of the document management server 10. As illustrated in FIG. 2, the document management server 10 is a server computer and includes a controller 11, a memory 12, and a communication unit 13, and the units are connected to one another via a bus 14. The controller 11 includes a central processing unit (CPU), for example, and executes a program stored on the memory 12 to thereby control the units in the document management server 10 and perform data processing. The memory 12 includes various memories, such as a hard disk and a random access memory (RAM), for example, stores the program executed by the controller 11 and various types of data, and is used as a work memory. The communication unit 13 includes a network card and performs data communication with external apparatuses.

The mail server 20 is a server computer and includes a controller, a memory, and a communication unit. The hardware configuration of the mail server 20 may be similar to that of the document management server 10. The mail server 20 transmits and receives emails relating to the document processing system 1. Here, the mail server 20 controls a process of transmitting and receiving emails relating to the domain of the company to which users belong.

The print management server 30 is a server computer and includes a controller, a memory, and a communication unit. The hardware configuration of the print management server 30 may be similar to that of the document management server 10. The print management server 30 controls print jobs relating to document data. In this exemplary embodiment, a case is described where the print management server 30 performs an on-demand print process. Document data is data in various forms, such as an image data, text data, rich text data, and the like.

The multifunction machine 40 is an image processing apparatus that has plural functions, such as functions of a copier, a printer, a scanner, and so on. The multifunction machine 40 performs printing by specifying or selecting document data registered on the print management server 30 and performs a print process on document data received from the in-house user terminal 50 via the LAN 60. The multifunction machine 40 may include a display, such as a liquid crystal panel, and an operation unit, such as various buttons. In this case, the multifunction machine 40 displays a list of print jobs on the display and performs a process on a print job registered on the print management server 30 in accordance with an operation performed on the operation unit.

The in-house user terminal 50 is a computer, such as a personal computer, a portable terminal, or the like, and includes a controller, a memory, a communication unit, an operation unit, and a display. The in-house user terminal 50 is regarded as a user's operation terminal in the document processing system 1. A user who uses the document processing system 1 is able to register a print job on the print management server 30 and to instruct the print management server 30 to perform on-demand printing by operating the in-house user terminal 50.

Note that various types of information storage media, such as semiconductor memories, may be used as the memories described above. In this exemplary embodiment, programs and various types of data stored on the memories may be obtained from external apparatuses via the respective communication units. Furthermore, the hardware configurations of the document management server 10 and so on are not limited to the examples described above and may include various types of existing hardware. For example, the document management server 10 and so on may include a reader that reads a program and data recorded on a computer readable information storage medium.

Referring back to FIG. 1, the document processing system 1 is connected to an external system 2 over a network N so as to be able to transmit and receive data. The external system 2 is a system on a network different from the network on which the document processing system 1 is present (that is, a network other than the LAN 60). In other words, the external system 2 is a system in which the management agency (for example, the operating company of the system) and the form of authentication are different from those of the document processing system 1. In a case where the document processing system 1 communicates with the external system 2 over the network N, security thereof may be ensured by a firewall. The external system 2 includes an external user terminal 70, a document storage server 80, and a printer 90, and these apparatuses are connected to one another over the network N so as to be able to transmit and receive data.

The external user terminal 70 is a computer, such as a personal computer, a portable terminal, or the like, and includes a controller, a memory, a communication unit, an operation unit, and a display. The external user terminal 70 is regarded as a user's operation terminal outside the document processing system 1. The memory of the external user terminal 70 stores document data. A user is able to register document data on the document storage server 80 by operating the external user terminal 70.

The document storage server 80 is a server computer and includes a controller, a memory, and a communication unit. The hardware configuration of the document storage server 80 may be similar to that of the document management server 10. The document storage server 80 stores document data received from the external user terminal 70 in a document storage database and transmits the document data to the printer 90 to make the printer 90 output the document data.

FIG. 3 is a diagram illustrating an example of data storage in the document storage database stored on the memory of the document storage server 80. As illustrated in FIG. 3, the document storage database stores authentication information, document data, print information, and expiration information for printing in association with one another.

Authentication information is information (for example, personal identification number (PIN)) needed to print a document corresponding to document data stored on the document storage server 80. In other words, authentication information is information used to uniquely identify document data. In a case where a user has authentication information, the document storage server 80 allows printing of a document corresponding to document data associated with the authentication information. In a case where a user does not have authentication information, the document storage server 80 does not allow printing of a document corresponding to document data. Authentication information may be information in a predetermined form and may be a symbol string (a character string, numeric characters, or the like), for example. When the document storage server 80 has received document data, the document storage server 80 generates authentication information in accordance with a predetermined generation method described in a program. For example, the document storage server 80 generates a symbol string that is determined in accordance with a predetermined method for generating a symbol string, as authentication information.

Print information is information indicating whether or not document data has been output by the printer 90. For example, print information has a value indicating that document data has not been output or a value indicating that document data has been output. The document storage server 80 updates print information after making the printer 90 print a document corresponding to document data.

Expiration information is information indicating an expiration time (for example, date and time) until which output of document data is allowed. When the document storage server 80 has received document data, the document storage server 80 stores an expiration time, which is a time a predetermined duration after the present time, as expiration information. For example, document data is printable until the expiration time indicated by the expiration information, but is no longer printable after the expiration time indicated by the expiration information.

When the document storage server 80 has received document data from the external user terminal 70, the document storage server 80 issues authentication information, associates the authentication information with the received document data, and registers the authentication information and the document data in the document storage database. The document storage server 80 communicates the authentication information and the expiration information to the user who has registered the document data, by using a predetermined communication method (for example, an email, a Web browser, or the like). In a case of printing a document corresponding to the document data using the printer 90 in a duration determined by the expiration information, the authentication information is needed.

The printer 90 is an image output device and prints a document corresponding to document data registered on the document storage server 80. In this exemplary embodiment, the printer 90 is located in a store, such as a convenience store. The printer 90 may include a display, such as a liquid crystal panel, and an operation unit, such as various buttons. A user inputs authentication information using the operation unit in accordance with guidance on a screen displayed on the display. The printer 90 transmits the authentication information to the document storage server 80 and receives print data (data for printing generated on the basis of document data) to thereby print a document corresponding to the document data registered by the user.

The document processing system 1 according to this exemplary embodiment is configured such that document data registered on the document storage server 80 is taken using authentication information, is associated with the user account, and is registered as a print job to thereby enable printing of a document corresponding to the document data using the multifunction machine 40 in the company instead of the printer 90 located in a store. Hereinafter, the configuration will be described in detail.

### 2. Functions Implemented by Document Processing System

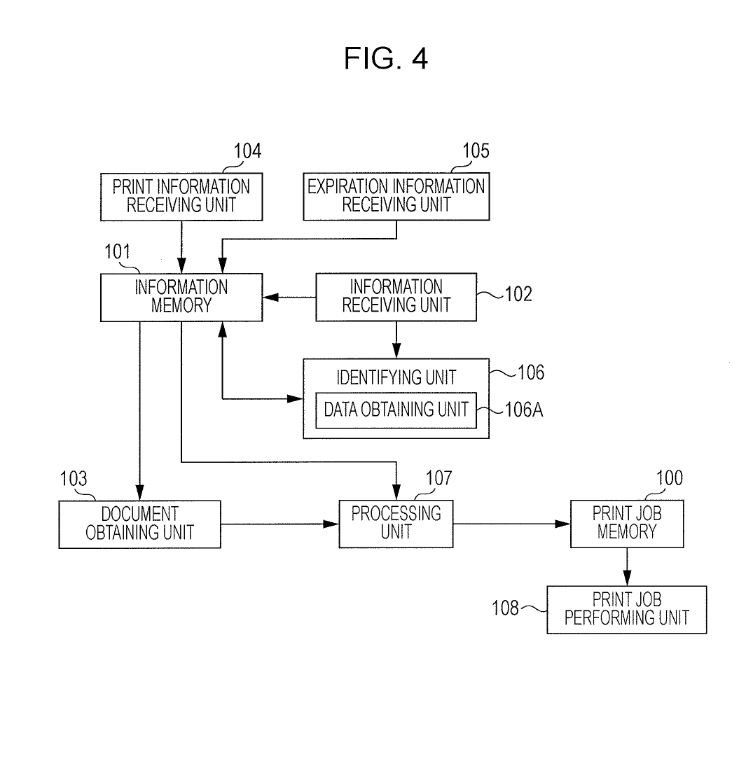

FIG. 4 is a functional block diagram according to this exemplary embodiment. As illustrated in FIG. 4, the document processing system 1 implements the functions of a print job memory 100, an information memory 101, an information receiving unit 102, a document obtaining unit 103, a print information receiving unit 104, an expiration information receiving unit 105, an identifying unit 106, a processing unit 107, and a print job performing unit 108.

### 2-1. Print Job Memory

The print job memory 100 is implemented as the memory of the print management server 30 and the like. The print job memory 100 stores a print job database that indicates print jobs to be performed by the multifunction machine 40. FIG. 5 is a diagram illustrating an example of data storage in the print job database. As illustrated in FIG. 5, the print job database stores job issuer information and document data in association with each other. As job issuer information, user identification information for identifying a user who has issued the print job is stored.

User identification information is information used to uniquely identify a user (information having a one-to-one correspondence with a user). Here, a case is described where a user account (work account) corresponds to user identification information. A user account is an account used when a user logs in to a print management system. Document data stored in the print job database is data of a document to be output. Document data itself may be stored, or information indicating a storage location of the document data (for example, the folder name or the file name) may be stored.

Note that data stored in the print job database is not limited to that described in the above example. It is sufficient that data for identifying a print job to be performed is stored in the print job database. For example, print conditions (the number of copies to be printed, print pages, and so on) specified by a user may be stored in the print job database.

### 2-2. Information Memory

The information memory 101 is implemented as the memory 12 and the like. The information memory 101 stores various types of data needed to register, in the print job database, a print job relating to document data registered on the document storage server 80. Next, as examples of data stored on the information memory 101, a company database and a job management database are described.

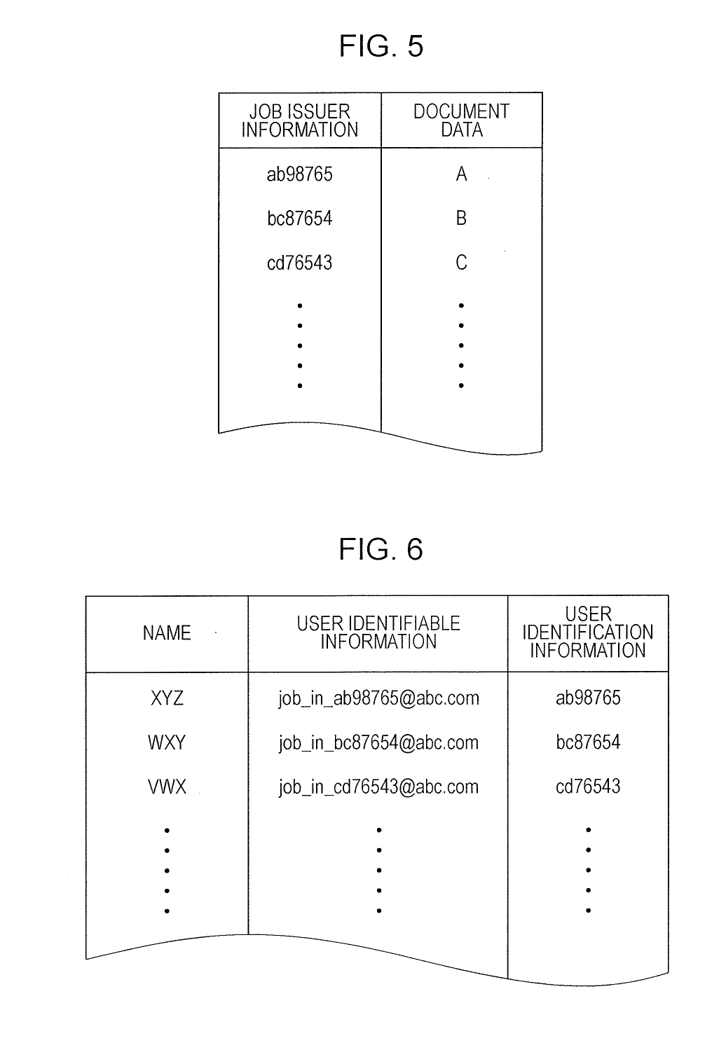

FIG. 6 is a diagram illustrating an example of data storage in the company database. The company database stores various types of information regarding users. Here, as illustrated in FIG. 6, the company database stores user names, user identifiable information, and user identification information in association with one another. In this exemplary embodiment, user identification information is an employee number, for example, and is identification information most frequently used in order to identify a user in the company. The number of printed pages may be added up for each piece of user identification information, or each piece of user identification information may be used as information indicating a user to whom print expenses are to be borne. User identifiable information is information used to uniquely identify user identification information (information having a one-to-one correspondence with user identification information). Here, a case is described where an email address of a user corresponds to user identifiable information.

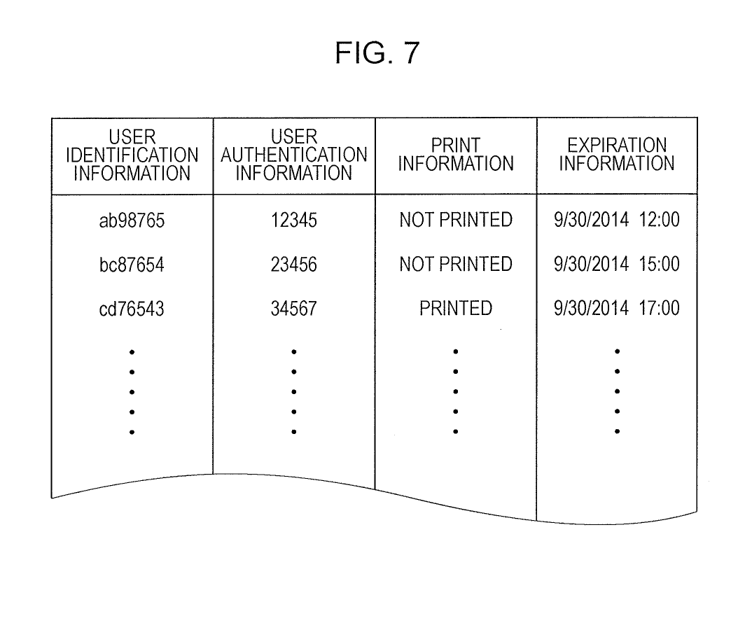

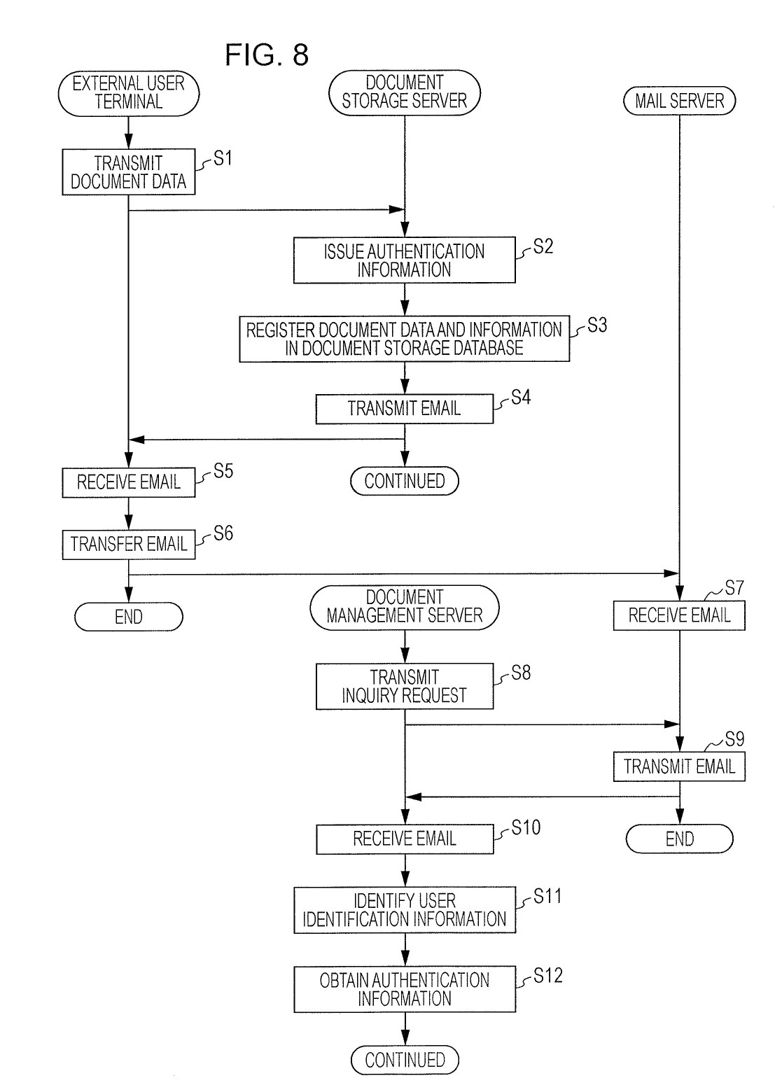

FIG. 7 is a diagram illustrating an example of data storage in the job management database. The job management database stores various types of information regarding document data that is obtained from the document storage server 80. Here, as illustrated in FIG. 7, the job management database stores user identification information, user authentication information, print information, and expiration information in association with one another. The document management server 10 may regularly make an inquiry about print information to the document storage server 80 to thereby update the print information.

Note that data stored in the company database and the job management database is not limited to those described in the above example. It is sufficient that data needed to register a print job in the print job database is stored in the company database and the job management database. For example, authentication information (password or the like) needed for a user to log in to the document processing system 1 may be stored in the company database, or an email transmitted by the external user terminal 70 may be stored in the job management database.

### 2-3. Information Receiving Unit

The information receiving unit 102 is implemented as the controller 11, the communication unit 13, and the like. The information receiving unit 102 receives, from the external user terminal 70, authentication information for obtaining document data (for example, data of a document to be printed) which is generated when the document data is registered on the document storage server 80, and user identifiable information. The authentication information and the user identifiable information are transmitted by the external user terminal 70 when a user performs a specific operation.

In this exemplary embodiment, the information receiving unit 102 receives an email that includes the authentication information and the user identifiable information. This email is transmitted to the mail server 20 when a user performs a specific operation on the external user terminal 70. For example, the user may perform an operation for transferring an email received from the document storage server 80, or a transfer setting may be performed in advance so as to transfer an email when the email is received from the document storage server 80. Alternatively, the user may create a new email. In this exemplary embodiment, an email address set as the destination address of the email corresponds to the user identifiable information for identifying user identification information to be associated with the document data.

### 2-4. Document Obtaining Unit

The document obtaining unit 103 is implemented as the controller 11, the communication unit 13, and the like. The document obtaining unit 103 obtains document data from the document storage server 80 by using authentication information. The document obtaining unit 103 transmits authentication information received by the information receiving unit 102 and an obtainment request for obtaining document data to the document storage server 80. When the document storage server 80 has received the obtainment request, the document storage server 80 determines whether or not the authentication information is present in the document storage database. If the document storage server 80 determines that the authentication information is not present, the document storage server 80 does not transmit document data to the document management server 10. If the document storage server 80 determines that the authentication information is present, the document storage server 80 transmits document data associated with the received authentication information to the document management server 10. The document obtaining unit 103 receives the transmitted document data.

### 2-5. Print Information Receiving Unit

The print information receiving unit 104 is implemented as the controller 11, the communication unit 13, and the like. The print information receiving unit 104 receives print information that indicates whether or not a document corresponding to document data registered on the document storage server 80 has been printed. The print information receiving unit 104 receives print information from the document storage server 80. The print information receiving unit 104 may make an inquiry about the latest print information to the document storage server 80 at the time of log-in by a user.

### 2-6. Expiration Information Receiving Unit

The expiration information receiving unit 105 is implemented as the controller 11, the communication unit 13, and the like. The expiration information receiving unit 105 receives expiration information regarding an expiration time until which document data registered on the document storage server 80 is printable. The expiration information receiving unit 105 receives expiration information from the document storage server 80.

### 2-7. Identifying Unit

The identifying unit 106 is implemented as the controller 11 and the like. The identifying unit 106 identifies user identification information on the basis of user identifiable information. The identifying unit 106 identifies user identification information associated with user identifiable information by referring to the company database. The identifying unit 106 in this exemplary embodiment includes a data obtaining unit 106A that obtains user identification information and associated data (in the company database in this case) which is an email address. The identifying unit 106 identifies user identification information on the basis of user identifiable information that is an email address relating to an email, and associated data (in the company database in this case). Here, user identifiable information is not limited to an email address relating to the email described above. The sender name, the source address, or a character string included in the body of the email may be used as user identifiable information.

### 2-8. Processing Unit

The processing unit 107 is implemented as the controller 11 and the like. The processing unit 107 processes document data and user identification information in association with each other. For example, the processing unit 107 performs a print process on document data. For example, when the processing unit 107 has accepted user identification information, the processing unit 107 processes document data that is stored in association with the user identification information. For example, the processing unit 107 records, on the print job memory 100, document data and user identification information in association with each other. The processing unit 107 registers, on the print job memory 100, information for allowing a user indicated by user identification information to output document data.

In this exemplary embodiment, the processing unit 107 first stores, in the job management database, user identification information identified by the identifying unit 106, authentication information received by the information receiving unit 102, print information received by the print information receiving unit 104, and expiration information received by the expiration information receiving unit 105. The processing unit 107 thereafter requests the print management server 30 to associate document data received by the document obtaining unit 103 with the user identification information and to register the document data and the user identification information in the print job database.

### 2-9. Print Job Performing Unit

The print job performing unit 108 is implemented as the controller of the print management server 30 and the like. The print job performing unit 108 performs a print job, when a user logs in to the document processing system 1 using user authentication information, on the basis of document data associated with user identification information of the user. The print job performing unit 108 refers to the print job database and makes the multifunction machine 40 output the document data associated with the user identification information of the logged-in user. In other words, the print job performing unit 108 prohibits performing of a print job relating to document data if the log-in is performed without using user identification information and user authentication information associated with the document data.

### 3. Process Performed in this Exemplary Embodiment

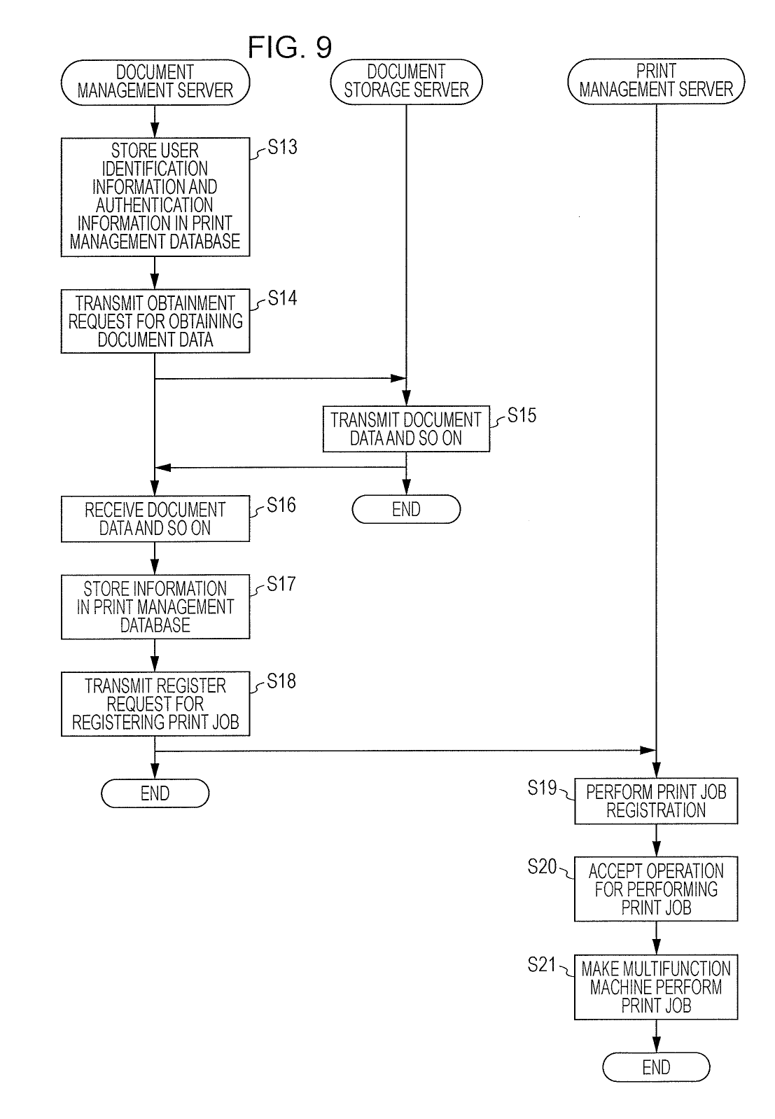

FIGS. 8 and 9 include a flowchart illustrating a process performed in this exemplary embodiment. Here, the controllers of the computers perform the process illustrated in FIGS. 8 and 9 in accordance with the programs stored on the memories, respectively. The process illustrated in FIGS. 8 and 9 is performed to thereby implement the functions illustrated in FIG. 4.

As illustrated in FIG. 8, the external user terminal 70 transmits document data to the document storage server 80 (step S1). The document data transmitted in step S1 may be stored on the memory of the external user terminal 70 or may be stored on an information storage medium connected to the external user terminal 70. Alternatively, the document data may be stored on another computer, for example.

When the document storage server 80 has received the document data transmitted by the external user terminal 70, the document storage server 80 issues authentication information (step S2). In step S2, the document storage server 80 generates authentication information for printing a document corresponding to the document data that is stored in the document storage database, in accordance with a predetermined method for generating a symbol string. Note that the document storage server 80 may generate authentication information on the basis of random numbers.

The document storage server 80 registers the document data, the authentication information, print information, and expiration information in the document storage database in association with one another (step S3). The print information has a value indicating that the document data has not been output. The expiration information has a value indicating a date and time a predetermined duration after the present time.

The document storage server 80 transmits an email addressed to an email address of the user who has transmitted the document data, the email including the authentication information (step S4). The email address of the user may be stored in advance on the memory of the document storage server 80 or may be received together with the document data. The email address in this case belongs to a domain different from the domain of mail addresses administered by the mail server 20 (for example, a domain other than the domain of the company to which the user belongs).

The external user terminal 70 receives the email transmitted by the document storage server 80 (step S5). As a result, the user obtains the authentication information for printing a document corresponding to the document data, and therefore, is now able to print the document corresponding to the document data by inputting the authentication information into the printer 90 located in a convenience store or the like. For example, when the user has input the authentication information into the printer 90, the printer 90 transmits the input authentication information to the document storage server 80. The document storage server 80 compares the authentication information input into the printer 90 with authentication information stored in the document storage database to thereby verify the credentials of the user. If the document storage server 80 determines that the user has credentials (the user is authorized to print a document corresponding to the document data), the document storage server 80 transmits data for printing a document corresponding to the document data to the printer 90, and the printer 90 prints the document corresponding to the document data on the basis of the data.

Referring back to FIG. 8, the external user terminal 70 transfers, to the mail server 20, the email received in step S5 in response to a user operation (step S6). The source address of the email transferred in step S6 is a personal email address of the user, and the destination address of the email is the user's work email address.

The mail server 20 receives the email transferred by the user (step S7). The email received in step S7 is recorded on the memory of the mail server 20. The document management server 10 transmits, to the mail server 20, an inquiry request for making an inquiry as to whether or not an email has been received (step S8). For example, the document management server 10 transmits such an inquiry request each time a predetermined interval has passed.

The mail server 20 transmits the received email to the document management server 10 (step S9). The document management server 10 receives the email (step S10). Here, the email includes the authentication information and user identifiable information. The document management server 10 refers to the company database and an email address in the email to thereby identify user identification information (step S11). In step S11, the document management server 10 refers to the email address that is set as the destination address of the email. Then, the document management server 10 refers to the company database and identifies a work account that is associated with the email address.

The document management server 10 obtains the authentication information included in the email (step S12). For example, it is assumed that a specific character string is inserted in the body of the email, and the authentication information is included in a position determined on the basis of the character string (for example, immediately after or immediately before the character string). Then, the document management server 10 searches for the specific character string in the email to thereby identify the position of the authentication information in the email.

Referring to FIG. 9, the document management server 10 stores the user identification information and the authentication information in the print management database (step S13). The document management server 10 transmits the authentication information and an obtainment request for obtaining document data to the document storage server 80 (step S14). The obtainment request may be transmitted in step S14 at a predetermined timing. For example, the obtainment request may be transmitted each time a predetermined interval has passed or may be transmitted at a predetermined time. Alternatively, the obtainment request may be transmitted when the user performs a predetermined operation on the multifunction machine 40 or on the in-house user terminal 50, for example.

When the document storage server 80 has received the authentication information from the document management server 10, the document storage server 80 verifies the validity of the authentication information and transmits document data, print information, and expiration information (step S15). In step S15, the document storage server 80 compares the authentication information received from the document management server 10 with authentication information stored in the document storage database. If the document storage server 80 determines that the authentication information received from the document management server 10 is present in the document storage database, the document storage server 80 transmits document data, print information, and expiration information associated with the authentication information. On the other hand, if the document storage server 80 determines that the authentication information received from the document management server 10 is not present in the document storage database, the document storage server 80 does not transmit document data and so on, and the process ends. In this case, the document storage server 80 may return a predetermined error message.

The document management server 10 receives the document data, the print information, and the expiration information (step S16). The document management server 10 stores the received print information and expiration information in the print management database (step S17). The document management server 10 transmits a register request for registering a print job to the print management server 30 using the user identification information and the document data (step S18).

When the print management server 30 has received the register request for registering a print job from the document management server 10, the print management server 30 performs print job registration (step S19). In step S19, the print management server 30 stores the user identification information as job issuer information in the print job database and records the document data in association with the user identification information.

The print management server 30 accepts an operation for performing the print job in response to a user operation performed on the operation unit of the multifunction machine 40 or the in-house user terminal 50 (step S20). The print management server 30 makes the multifunction machine 40 perform the print job by using the document data for which printing has been requested (step S21).

### 4. Modifications

Note that the present invention is not limited to the above-described exemplary embodiment, and may be modified as appropriate without departing from the spirit thereof.

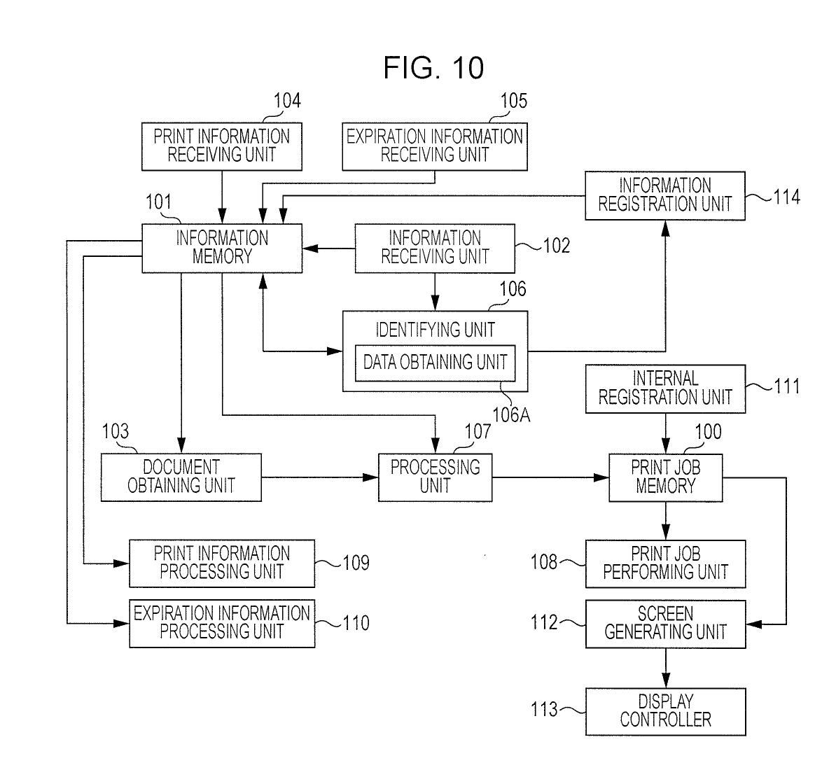

FIG. 10 is a functional block diagram according to modifications. As illustrated in FIG. 10, in modifications, the functions of a print information processing unit 109, an expiration information processing unit 110, an internal registration unit 111, a screen generating unit 112, a display controller 113, and an information registration unit 114 are implemented in addition to the functions described in the exemplary embodiment. Note that processes performed by the print information processing unit 109 and the expiration information processing unit 110 may be performed by the processing unit 107.

(1) For example, the document processing system 1 may include the print information processing unit 109. The print information processing unit 109 is implemented as the controller of the print management server 30 and the like. The print information processing unit 109 performs processes relating to output of document data on the basis of print information. For example, the print information processing unit 109 refers to print information and determines whether or not document data has been output in the external system 2. The processes relating to output of document data are processes described below, for example.

For example, the print information processing unit 109 performs display control of a screen (a screen displayed on the display of the multifunction machine 40 or of the in-house user terminal 50, for example) used to perform a print job, on the basis of print information. In this case, the print information processing unit 109 displays an image (a message, for example) corresponding to the print information on the screen. For example, in a case where the print information indicates that output has been performed in the external system 2, the print information processing unit 109 displays, on the screen, a message indicating that output has been performed.

The print information processing unit 109 may restrict reception of document data registered on the external system 2, on the basis of print information, for example. In this case, in the case where the print information indicates that output has been performed in the external system 2, the print information processing unit 109 need not make an obtainment request for obtaining document data to the external system 2, and, in a case where the print information indicates that output has not been performed in the external system 2, the print information processing unit 109 need not allow an obtainment request for obtaining document data to be made to the external system 2.

The print information processing unit 109 may restrict output of document data registered in the print job database, on the basis of print information. In this case, in the case where the print information indicates that output has been performed in the external system 2, the print information processing unit 109 may prohibit output of the document data registered in the print job database or may erase the document data registered in the print job database.

(2) For example, the document processing system 1 may include the expiration information processing unit 110. The expiration information processing unit 110 performs processes relating to output of document data on the basis of expiration information. For example, the expiration information processing unit 110 refers to expiration information to thereby determine whether or not an expiration time indicated by the expiration information has passed.

For example, the expiration information processing unit 110 performs display control of the screen (the screen displayed on the display of the multifunction machine 40 or of the in-house user terminal 50, for example) used to perform a print job, on the basis of expiration information. In this case, in a case where an expiration time indicated by the expiration information has passed, the expiration information processing unit 110 displays, on the screen, a message indicating that the expiration time has passed.

The expiration information processing unit 110 restricts output of document data on the basis of expiration information, for example. In this case, in the case where an expiration time indicated by the expiration information has passed, the expiration information processing unit 110 may prohibit output of the document data registered in the print job database or may erase the document data registered in the print job database.

(3) For example, the document processing system 1 may include the internal registration unit 111, the screen generating unit 112, and the display controller 113. The internal registration unit 111, the screen generating unit 112, and the display controller 113 are implemented as the controller of the print management server 30 and the like. The internal registration unit 111 registers, on the print job memory 100, document data received from a computer (for example, the in-house user terminal 50) in the document processing system 1. For example, document data is stored on the memory of the in-house user terminal 50, and the in-house user terminal 50 transmits the document data to the print management server 30 in response to a user operation performed on the operation unit. The internal registration unit 111 of the print management server 30 receives the document data and registers the document data in the print job database in association with user identification information of the user to thereby register a print job relating to the document data.

In the modification described in (3), each piece of document data registered in the print job database is associated with information for identifying whether the piece of document data has been received from the document storage server 80 or from the in-house user terminal 50. Accordingly, when the processing unit 107 registers document data, information indicating that the document data has been received from the document storage server 80 is associated with the document data and registered. When the internal registration unit 111 registers document data, information indicating that the document data has been received from the in-house user terminal 50 is associated with the document data and registered.

The screen generating unit 112 generates screen information (data displayed on a screen) for outputting document data stored in the print job database. The display controller 113 displays the generated screen information in which document data received from the document storage server 80 is distinguishable from document data received from a computer (for example, the in-house user terminal 50) in the document processing system 1. The display controller 113 displays, on the display of the multifunction machine 40 or of the in-house user terminal 50, a screen on which whether the document data has been received from the document storage server 80 or has been received within the document processing system 1 is identified. On this screen, information may be displayed which indicates whether document data of each print job has been received from the document storage server 80 or has been received within the document processing system 1. For example, the display controller 113 displays an image representing document data received from the external system 2 in a first display mode (for example, in a first color) and displays an image representing document data received from the in-house user terminal 50 in a second display mode (for example, in a second color).

(4) For example, the document processing system 1 may include the information registration unit 114. The information registration unit 114 is implemented as the controller 11 of the document management server 10 and the like. The information registration unit 114 registers, on the information memory 101, authentication information and user identification information in association with each other. That is, in this case, the information registration unit 114 stores, in the job management database, authentication information and user identification information in association with each other, although such a process is performed by the processing unit 107 in the exemplary embodiment.

The document obtaining unit 103 according to the modification described in (4) receives, in a case where a log-in process of logging in to the document processing system 1 is performed, document data using authentication information associated with user identification information of the logged-in user. That is, the document obtaining unit 103 refrains from obtaining document data associated with authentication information until a log-in process for a user is performed, and receives the document data after the log-in process has been performed.

(5) For example, the exemplary embodiment and plural modifications may be combined.

For example, in a case where it is desired to register document data as print jobs of plural users, email addresses of the plural users may be specified as destination addresses of the email. In this case, the identifying unit 106 identifies plural pieces of user identification information respectively associated with the plural email addresses. The processing unit 107 associates the document data with the pieces of user identification information and registers the document data and the pieces of user identification information in the print job database.

Although the case has been described above where a user who has registered document data associates the document data with his/her work account, a user who has registered document data may be different from a user indicated by user identification information associated with the document data, for example. In this case, a user indicated by the source email address of an email received by the mail server 20 is different from a user indicated by the destination email address of the email.

Although the case has been described where the identifying unit 106 identifies user identification information using the destination email address of an email, the identifying unit 106 may identify user identification information using the source email address of the email, for example. In this case, the source email address and user identification information are stored in association with each other in the company database, and the identifying unit 106 identifies the user identification information associated with the source email address of the email. The destination address of an email received by the mail server 20 need not be a work email address of a user and may be a receive-only email address, for example. In this case, the body of the email may include user identifiable information, or the source email address may correspond to user identifiable information as described above. Furthermore, it is sufficient that user identifiable information is information with which user identification information is identifiable, and user identifiable information may be user identification information itself. In this case, the body of an email may include the work account of the user. That is, a work account included in an email transmitted by the external user terminal 70 corresponds to user identifiable information, and a work account identified by the document management server 10 from the email is user identification information.

The document storage server 80 may delete document data, the corresponding document having been printed by the printer 90, from the document storage database, for example. Similarly, the print management server 30 may delete document data, the corresponding document having been printed by the multifunction machine 40, from the print job database.

A method for communicating authentication information and user identifiable information to the document processing system 1 is not limited to a method using an email. It is sufficient that the document processing system 1 receives a notification that includes authentication information and user identifiable information. Alternatively, a message transmitted and received in a social networking service may be used, for example.

For example, a timing at which the document processing system 1 obtains document data from the external system 2 is not limited to that in the example described above. The document processing system 1 may make an obtainment request for obtaining document data at a predetermined obtainment timing, or may make an obtainment request for obtaining document data when a user provides an instruction for performing a print job.

Although the case has been described where a document corresponding to document data registered by the document processing system 1 is printed by the multifunction machine 40, document data may be output by using a method other than printing, for example. Document data may be output by displaying the document data on the display of the multifunction machine 40 or of the in-house user terminal 50, or document data may be output by transmitting the document data to the multifunction machine 40 or to the in-house user terminal 50, for example. The document storage server 80 and the printer 90 may be included in the document processing system 1, for example.

The processes and data formats described above are merely examples, and various modifications may be made without departing from the spirit of the present invention, for example. It is sufficient that each functional block described above is implemented by using a computer included in the document processing system 1, and each functional block need not be implemented by the document management server 10. Furthermore, it is sufficient that the document processing system 1 implements the functions of the information receiving unit 102, the document obtaining unit 103, the identifying unit 106, and the processing unit 107, and the other functions may be omitted. The document processing system 1 may be implemented by using a single computer, for example.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document processing system comprising:
an information receiving unit that receives, from a user terminal, authentication information for obtaining document data, the authentication information being generated in response to registration of the document data on a server, and user identifiable information;
a document obtaining unit that obtains the document data from the server by using the authentication information;
an identifying unit that identifies user identification information by using the user identifiable information; and
a processing unit that processes the document data and the user identification information in association with each other.

2. The document processing system according to claim 1, wherein
the processing unit performs a print process on the document data.

3. The document processing system according to claim 1, further comprising:
a memory that stores the document data and the user identification information in association with each other, wherein
the processing unit processes the document data stored in association with the user identification information, in response to acceptance of the user identification information.

4. The document processing system according to claim 2, further comprising:
a print information receiving unit that receives print information indicating whether or not document data which corresponds to the document data and which is registered on the server has been printed, wherein
the processing unit performs a process relating to output of the document data in accordance with the print information.

5. The document processing system according to claim 2, further comprising:
an expiration information receiving unit that receives expiration information regarding an expiration time until which the document data registered on the server is printable, wherein
the processing unit controls whether or not output of the document data is allowed in accordance with the expiration information.

6. The document processing system according to claim 3, wherein
the memory stores document data received from a computer in the document processing system and user identification information in association with each other, and
the document processing system further comprises:
a screen generating unit that generates screen information for outputting the document data stored on the memory; and
a display controller that displays the generated screen information in which the document data received from the server is distinguishable from the document data received from the computer in the document processing system.

7. The document processing system according to claim 3, wherein
the memory stores the authentication information and the user identification information in association with each other, and
the document obtaining unit obtains, in a case where a log-in process of logging in to the document processing system is performed, the document data from the server by using the authentication information associated with the user identification information of a user who is logged in.

8. The document processing system according to claim 1, wherein
the information receiving unit receives an email that includes the authentication information and the user identifiable information.

9. The document processing system according to claim 8, wherein
the identifying unit identifies the user identification information by using the user identifiable information included in the email.

10. A non-transitory computer readable medium storing a program causing a computer to execute a process for document processing, the process comprising:
receiving, from a user terminal, authentication information for obtaining document data, the authentication information being generated in response to registration of the document data on a server, and user identifiable information;
obtaining the document data from the server by using the authentication information;
identifying user identification information by using the user identifiable information; and
processing the document data and the user identification information in association with each other.

11. A document processing apparatus, comprising:
an information receiving unit that receives, from a user terminal, authentication information for obtaining document data, the authentication information being generated in response to registration of the document data on a server, and user identifiable information;
a document obtaining unit that obtains the document data from the server by using the authentication information;
an identifying unit that identifies user identification information by using the user identifiable information; and
a processing unit that processes the document data and the user identification information in association with each other.

12. A document processing method comprising:
receiving, from a user terminal, authentication information for obtaining document data, the authentication information being generated in response to registration of the document data on a server, and user identifiable information;
obtaining the document data from the server by using the authentication information;
identifying user identification information by using the user identifiable information; and
processing the document data and the user identification information in association with each other.
